(19) United States
(12) Patent Application Publication
(10) Pub. No.: US 2007/0064003 A1
(43) Pub. Date: Mar. 22, 2007

(54) Net of regular shapes and a method of constructing a three-dimensional object

(75) Inventor: Nicholas Andrew Crossland, Sheffield (GB)

Correspondence Address: James C. Wray, Suite 300, 1493 Chain Bridge Road, McLean, VA, 22101, US

(73) Assignee: Panoptics Immersive Media Limited

(21) Appl. No.: 11/520,136

(22) Filed: Sep. 13, 2006

(30) Foreign Application Priority Data
Sep. 14, 2005 (GB) 05 18 699.4

(51) Int. Cl. G06T 15/20

(52) U.S. Cl. 345/427

(57) ABSTRACT

A net (902) of regular two-dimensional shapes applied to a sheet material (901) such that the net is foldable into a three-dimensional object (1901). A panoramic image (701) is applied to the net (901) to present a panorama over the three-dimensional object (1901) when assembled. The net (901) includes a plurality of tabs (1001, 1007) and a plurality of slots (1003, 1008) such that each tab is insertable into a respective one of the slots during the process of assembly into the three-dimensional object (1901).

### CROSS REFERENCE TO RELATED APPLICATION

This application claims priority from United Kingdom Patent Application No. 05 18 699.4, filed 14 Sep. 2005, the entire disclosure of which is incorporated herein by reference in its entirety.

### BACKGROUND OF THE INVENTION

The present invention relates to a net of regular shapes applied to a sheet material. The sheet material is appropriately printed, cut and scored to allow it to be assembled into a three-dimensional object without the need for tools or glue.

Possible applications of printed three-dimensional objects are many and varied. They can be used as promotional or advertising material, as souvenirs from places of interest, and can be made on various scales to serve differing purposes.

### BRIEF SUMMARY OF THE INVENTION

According to an aspect of the present invention, there is provided a net of regular two-dimensional shapes applied to a sheet material such that said net is foldable into a three-dimensional object, wherein a panoramic image is applied to said net to present a panorama over said three-dimensional object when assembled. Said net includes a plurality of tabs and a plurality of slots such that each tab is insertable into a respective one of said slots during the process of assembly into said three-dimensional objects.

### BRIEF DESCRIPTION OF THE SEVERAL VIEWS OF THE DRAWINGS

FIG. 1 shows examples of three-dimensional objects;

FIG. 2 shows a net which would produce a rhombic tricontahedron;

FIG. 3 shows the procedure for creating a three-dimensional object with a panoramic image applied thereto;

FIG. 4 shows examples of images captured at step 301;

FIG. 5 shows detail of step 302;

FIG. 6 shows detail of step 501

FIG. 7 shows the image resulting from assembling the captured images such as those shown in FIG. 4;

FIG. 8 shows a representation of data stored within processing system 601;

FIG. 9 shows sheet material printed with a required image;

FIG. 10 shows the sheet material of FIG. 9 once cutting and scoring has taken place;

FIG. 11 shows details procedures for assembly of a three-dimensional object;

FIG. 12 shows illustrates the removal of the finished product from its packaging;

FIG. 13 shows the net being folded along its score lines;

FIG. 14 shows the net being folded to form slots;

FIG. 15 shows the tabs being folded;

FIG. 16 shows a tab being inserted into a slot;

FIG. 17 shows the net beginning to take shape into an object;

FIG. 18 shows the object almost complete;

FIG. 19 shows the finished object; and

FIG. 20 shows an alternative embodiment which can act as a desk tidy.

### WRITTEN DESCRIPTION OF THE BEST MODE FOR CARRYING OUT THE INVENTION

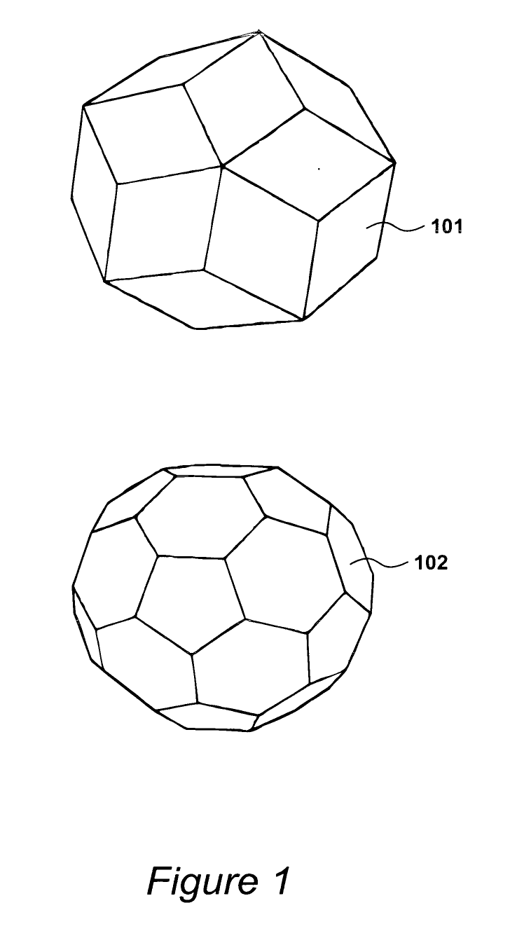

FIG. 1

An embodiment of the invention allows a 360°×180° spherical panorama to be displayed on a three-dimensional physical object and can be constructed without tools or glue. Examples of these three-dimensional objects are shown in FIG. 1 in which a rhombic tricontahedron is shown at 101 and a truncated isocahedron is shown at 202. Object 101 has 30 faces and this object will provide the basis for the description of an embodiment, but it should be appreciated that many objects of this type could be used, each assembled from a net of two-dimensional shapes.

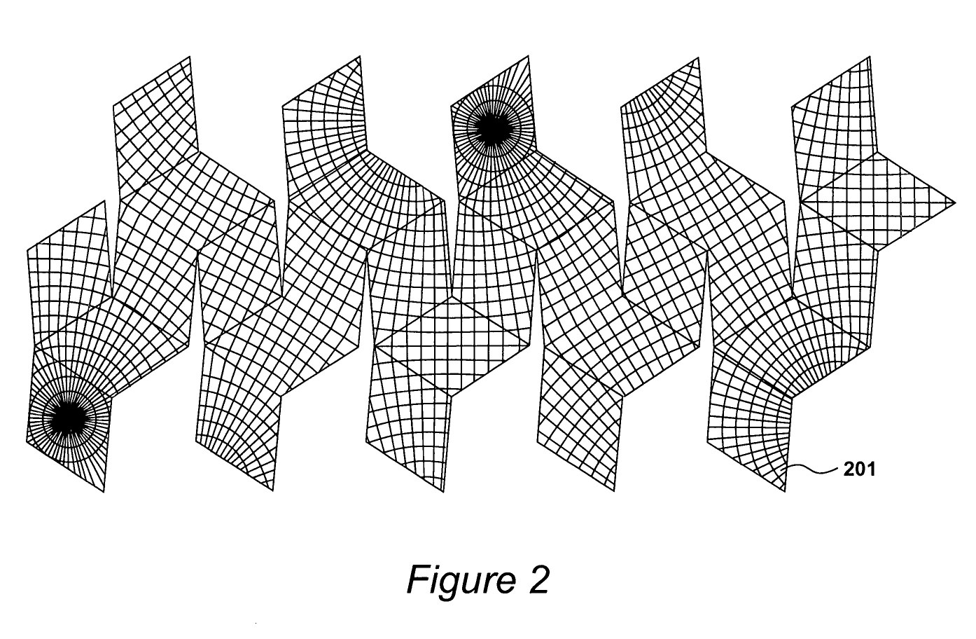

FIG. 2

A net 201 which could be used to produce a rhombic tricontahedron such as that shown at 101 is shown in FIG. 2. In certain situations, it may be desirable to apply an image to the outer surface of an object such as 101. FIG. 2 illustrates the mathematical transformation required in order to apply an image to the outer surface of object 101, such that when the image is viewed it does not appear distorted.

This transformation from a panoramic image to the desired size, shape and layout of a net is achieved using the commercially available Flexibly®) software.

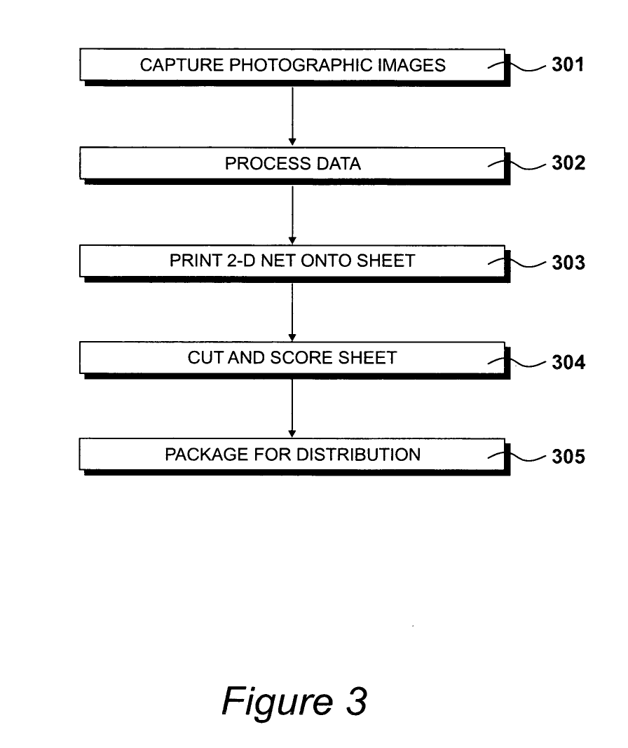

FIG. 3

A procedure for creating a three-dimensional object such as those shown in FIG. 1 with a panoramic image applied thereto is shown in FIG. 3. At step 301 photographic images are captured, preferably using a digital camera or, alternatively, using a conventional film camera, whereafter the images produced are scanned into digital form.

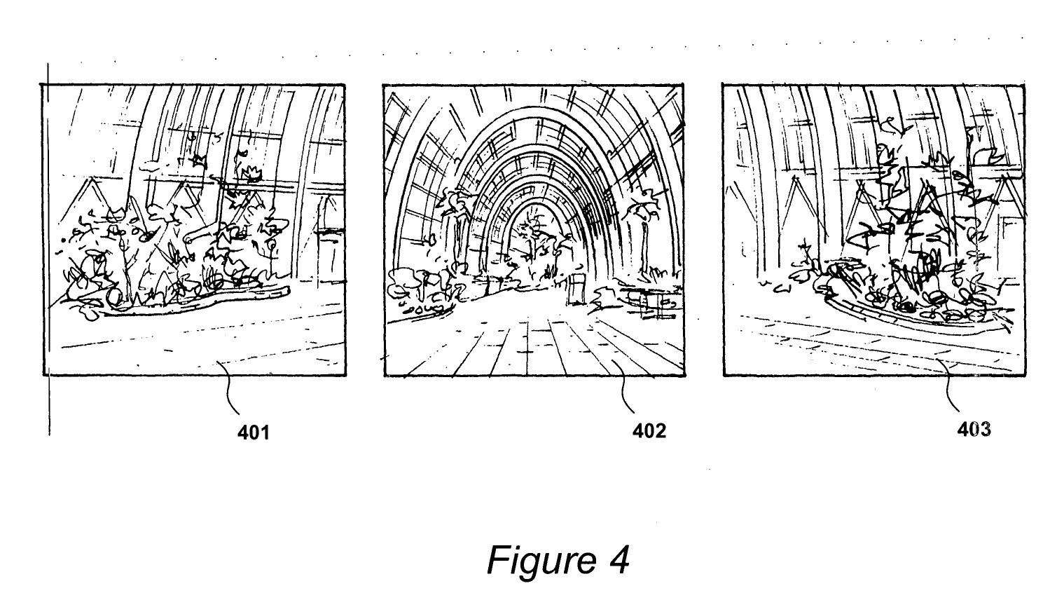

The number of original images required will depend upon the definition to be obtained in the finished object. In a typical example, such as that required for the establishment of a panoramic view on a website, sixteen images are taken, typically using a camera lens with a focal length of 16 millimeters or less (for digital images). Step 301 is further described with reference to FIG. 4.

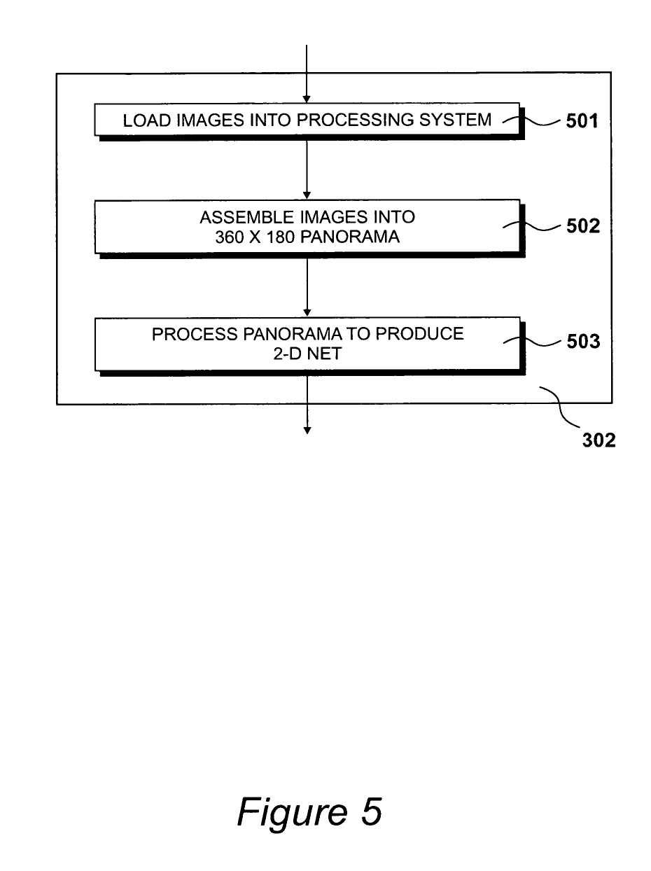

At step 302 data produced from said captured photographic images is processed. This step is further described with reference to FIGS. 5, 6, 7 and 8.

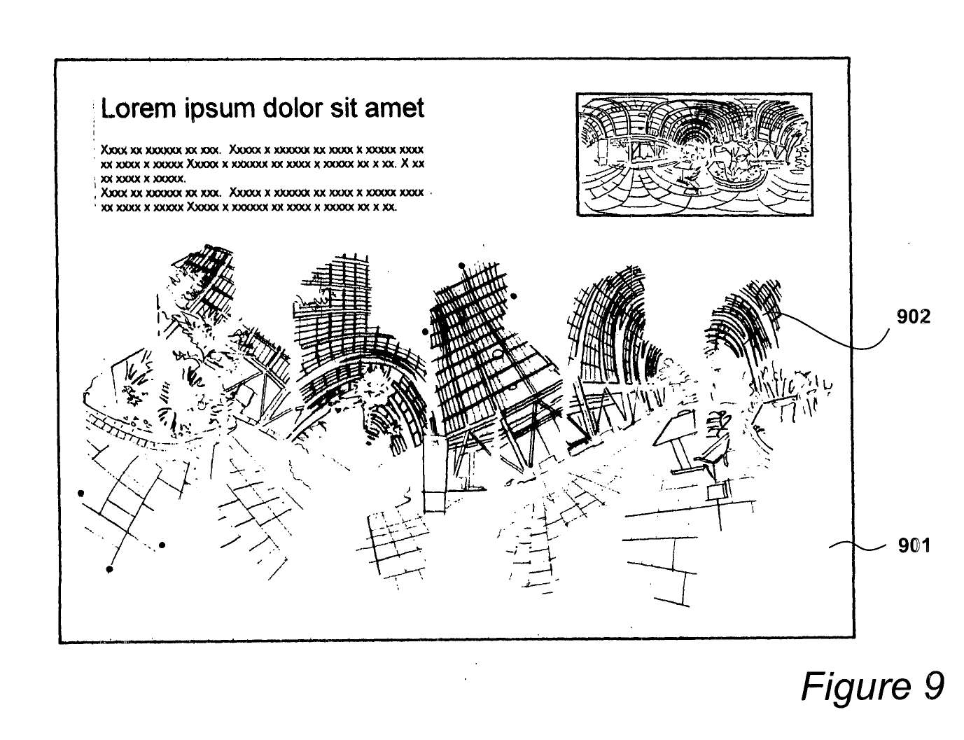

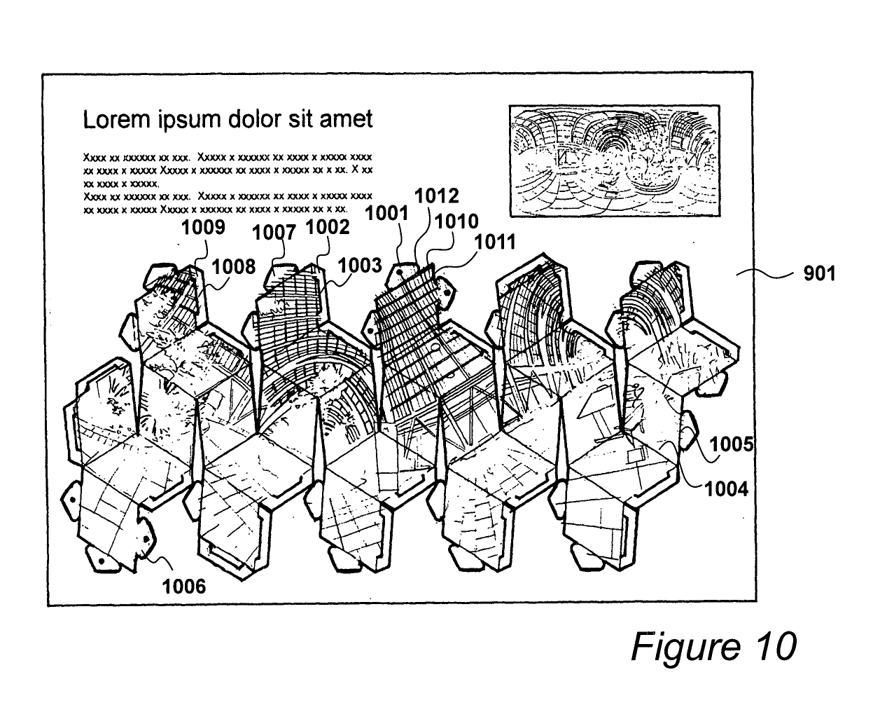

Once data has been processed at step 302, a two-dimensional net is printed onto a sheet of the desired material at step 303. This is further described with reference to FIG. 9. The sheet is then cut and scored at step 304, which is further detailed in FIG. 10. Finally the sheet is packaged for distribution at step 305.

In an alternative embodiment, the sheet of material is pre-cut and scored before printing.

FIG. 4

FIG. 4 shows examples of images captured at step 301. A series of images is captured, preferably by use of a digital camera. Typically, around sixteen images are captured. Depending upon the application for any particular set of images, different numbers of images at different resolutions may be required. Images such as image 401, 402 or 403 are then processed at step 302, as described with reference to FIG. 5.

FIG. 5

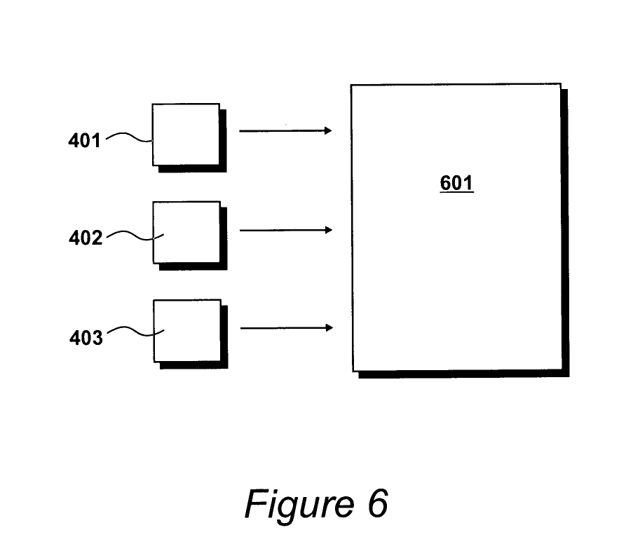

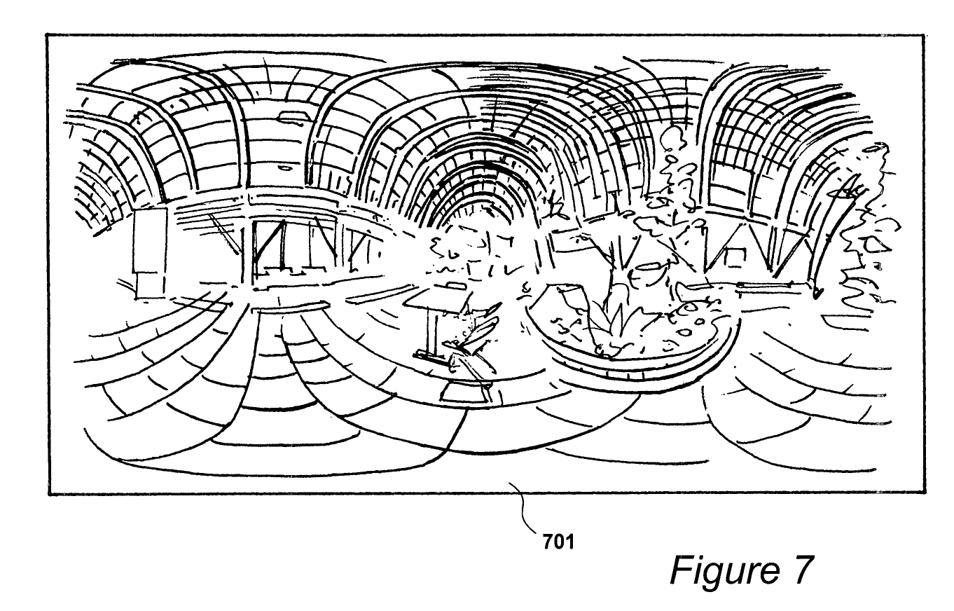

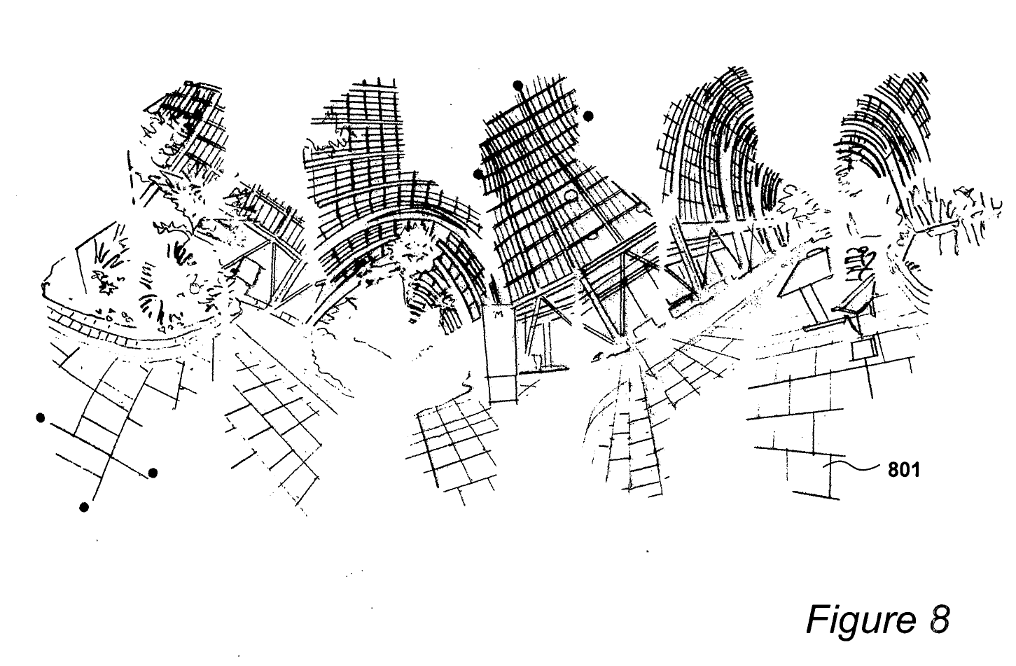

FIG. 5 shows detail of step 302. At step 501, images are loaded into a processing system. This is further described with reference to FIG. 6. At step 502, images are assembled into a 360°×180° panorama. An example of an image such as this is shown in FIG. 7. The panorama is processed at step 503 to produce a two-dimensional net such as that shown in FIG. 8.

FIG. 6

FIG. 6 shows details of step 501. Images such as images 401, 402 and 403 are input into a processing system 601. Within the image processing system, it is possible to effect modifications to the color components themselves, such as providing a degree of colour correction between the images. In this way, it should be possible to avoid discontinuities as the images are assembled together.

FIG. 7

The product of data processing what takes place on processing system 601 is shown in FIG. 7. The images such as images 401, 402 and 403 have been assembled appropriately to form a panoramic view 701. Panoramic view 701 is an equirectangular projection. Software exists for performing this transformation, such as that licensed under the trademark Realviz Stitcher. In this example, a 360°×180° panorama has been produced. In reality, a 360° by around 160° panorama is generally considered sufficient.

This allows the images to be captured using a digital camera on a tripod, without creating difficulties in terms of obtaining images which are around the legs of the tripod. However, in certain circumstances the full 180° degrees may be required if specific detail is to be reproduced from a ceiling or a floor for example. The gap that results from using a 160° vertical tilt can be filled by digital manipulation. In certain circumstances, a panorama of less than 360° (or less than 180° vertically) may also be desirable if, for example, part of the image is to contain textural matter such as corporate information or advertising etc.

Once the images have been assembled into a panorama such as that shown in FIG. 7, in a website environment it is possible to navigate around this so as to be presented with a three-dimensional environment, using software such as Quicktime® VR movie. The projection shown in FIG. 7 is such that if the image were to be placed around a sphere, it would fully encompass this sphere and provide images to a viewer that looked natural as if seen in a three-dimensional environment. In the present embodiment, it is desirable to display the spherical panorama on a three-dimensional shape and, as provided by an aspect of the present invention, the arrangement is such that the three-dimensional shape can be constructed without tools or glue. FIG. 8

FIG. 8 shows a two-dimensional net 801 produced by the software at step 503. It should be appreciated that FIG. 8 represents the data stored within the processing system 601, and not an actual printed image.

The printed image is shown in FIG. 9. The image has been appropriately manipulated by software to wrap it around the desired shape, in this case a rhombic tricontahedron such as that shown at 101. Once the image has been manipulated to produce a net such as that shown in FIG. 8, it can be printed onto the desired sheet material, which is further described with reference to

FIG. 9

FIG. 9 shows sheet material 901 printed with the net 902 generated at step 503 and represented in FIG. 8. The net 902 is foldable into a three-dimensional object such as object 101. The panoramic image represented in FIG. 7 has been applied to the net such that a panorama will be presented over the three-dimensional object 101 when the object has been assembled.

The sheet of material may consist of a card material having a sufficient thickness so as to support a three-dimensional object, but at the same time being sufficiently thin so as to facilitate scoring and folding. The card may have a laminate finish applied thereto, such as a matte finish, so as to enhance quality. Altematively, the material may take the form of a plastics material provided that the plastics material is again of an appropriate thickness to sustain the shape of the three-dimensional object while at the same time facilitating folding. In the present embodiment, the image is printed onto a sheet of material together with further information, such as information regarding the image and assembly instructions for construction of the object.

FIG. 10

FIG. 10 shows sheet material 901 as illustrated in FIG. 9, once cutting and scoring has taken place. Tabs such as tab 1001 and flaps such as flap 1002 defining slots such as slot 1003 are formed by cutting. In addition, scoring takes place along score lines such as line 1004 and line 1005 etc, to enable precise and neat folding during assembly into a three-dimensional object. In addition, the outline of the whole net 902, including the outline of the tabs, is perforated such that the net 902 as a whole is readily removed from the sheet 901 prior to assembly by popping out the net 902 along the perforations.

A plurality of tabs and flaps defining slots are created. Examples of these are tabs 1001 and 1007. For example, tab 1001 is insertable into a slot 1003 defined by flap 1002 and tab 1007 is insertable into a slot 1008 defined by flap 1009.

Each tab extends from a respective edge of one of the printed two-dimensional shapes. Thus in this example tab 1001 extends from edge 1010 of shape 1011. The width of tab 1001 increases to a size larger than the width of its respective slot so as to provide a maximum width at location 1012. This width is larger than the width of the slot 1003 with which the tab engages such that, once engaged by the application of force, the tab is retained therein. In order to facilitate the insertion process, the tab preferably increases in width such as to define a substantially circular curve. Thereafter, again to facilitate insertion of the tab, the tab preferably decreases in width so as to define a point. The resulting overall shape is therefore substantially similar to that provided by a spade as represented in a pack of cards.

In the present embodiment, some tabs such as tab 1006 are marked to indicate that during assembly these tabs should be inserted into their respective slots last, after the rest of the object has been assembled.

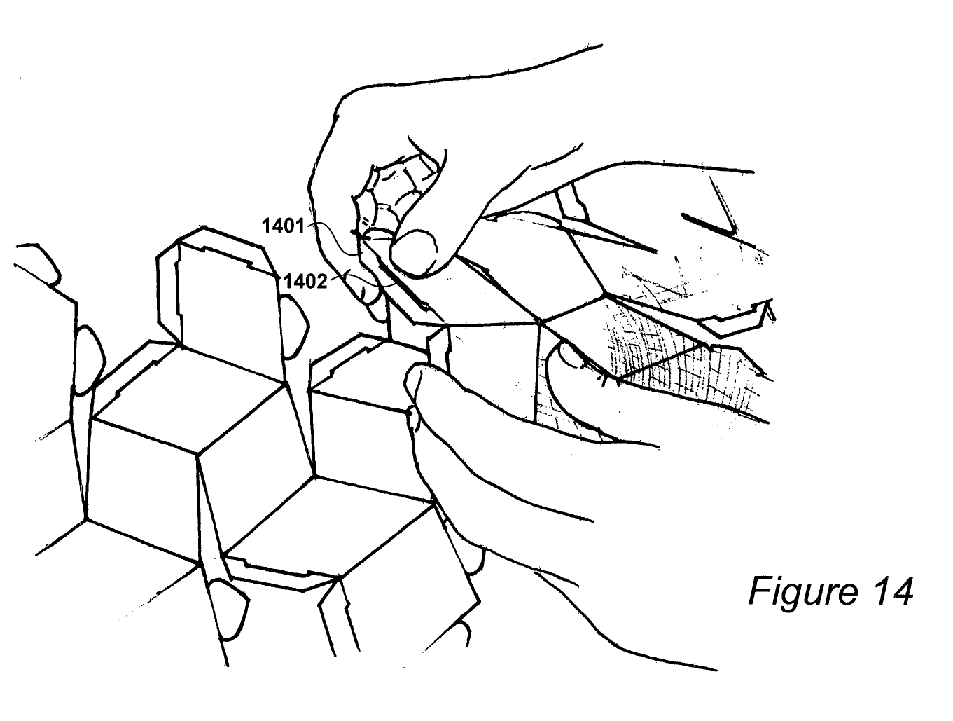

Each slot is formed by a stepped cut in a flap so that when a flap is folded a rectangular hole (or slot) is formed. This is further described with reference to FIG. 14.

The shape of the tabs and slots is such as to ensure that the object remains held together, again without the application of additional materials. In this way, the object is readily assembled without using glues. Glues present problems in that weak glues may result in the object becoming disassembled at a later date, with stronger glues, such as super glue, presenting problems in that they would not be appropriate for use by small children.

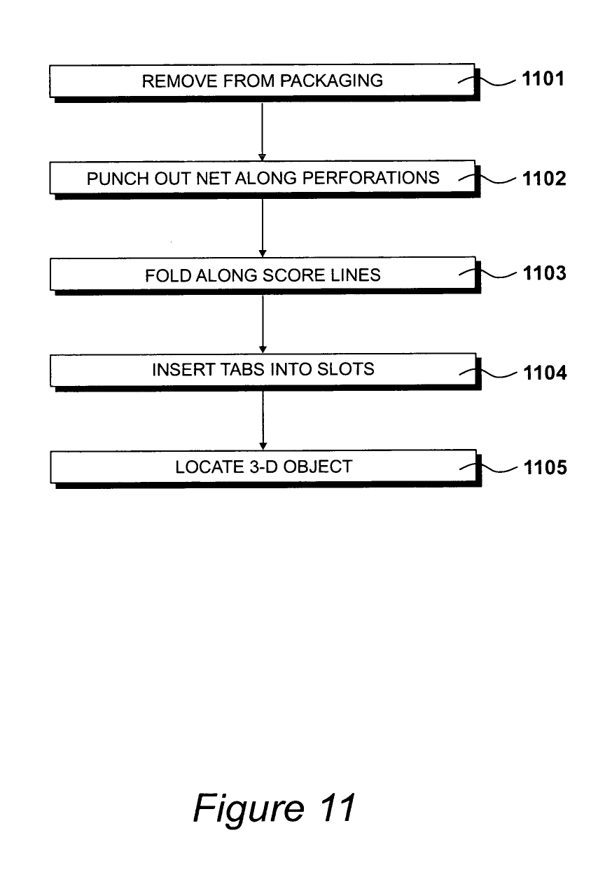

FIG. 11

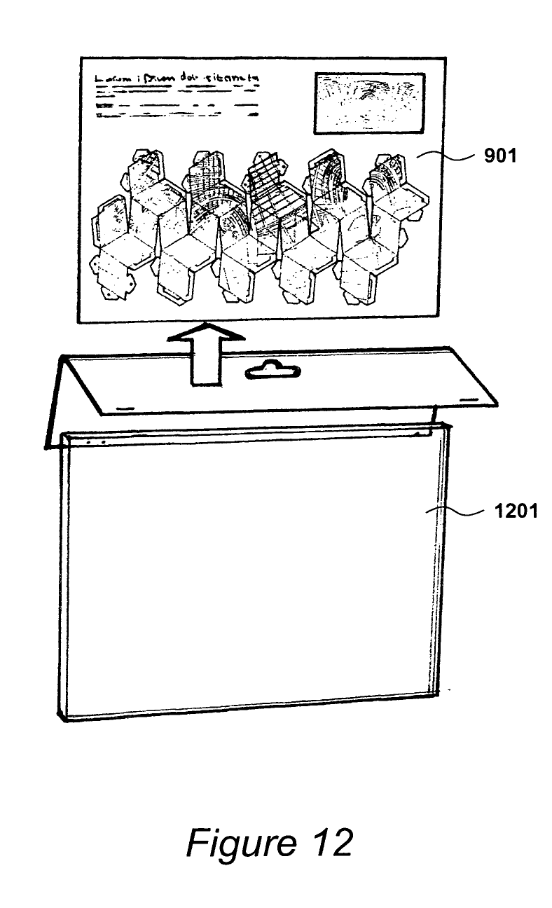

Procedures for assembly of a three-dimensional object such as object 101 are described with reference to FIG. 11. At step 1101, sheet material is removed from its packaging. This is further illustrated in FIG. 12. The net is punched out from the sheet material at step 1102, using the pre-cut perforations.

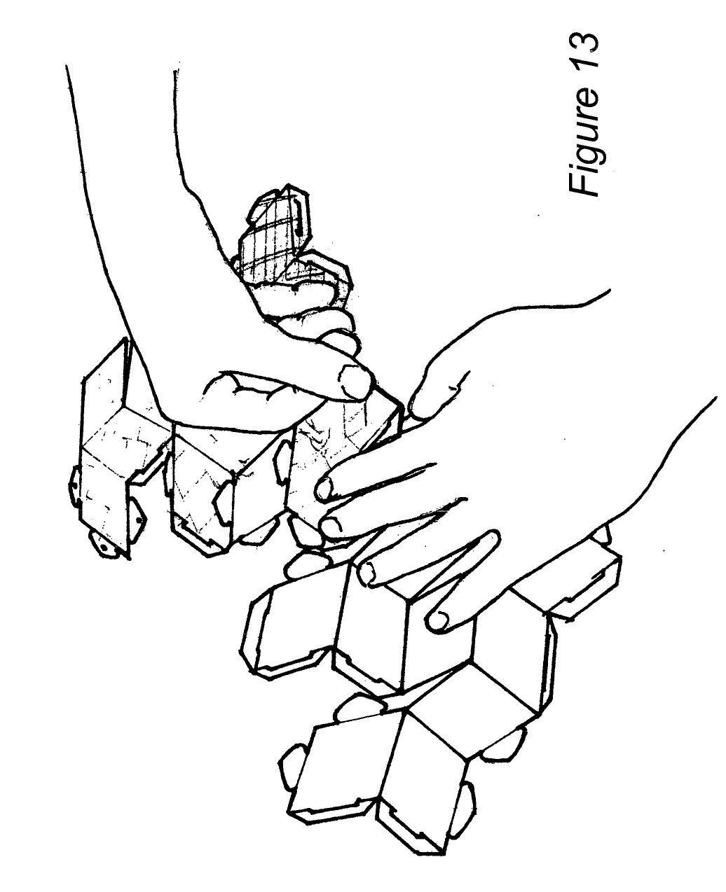

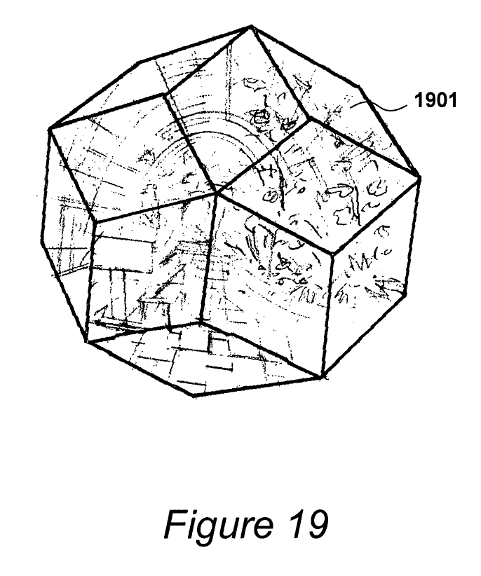

At step 1103, the net is folded along its pre-scored lines. This is further described with reference to FIG. 13. At step 1104 Each of the tabs is then inserted into its respective slot, as illustrated in FIG. 14. Finally, at step 1105 the three-dimensional object is complete as shown in FIG. 19 and can be located as desired, possibly being hung from a ceiling so as to give maximum effect to the three-dimensional presentation.

FIG. 12

FIG. 12 shows the finished product 901 being removed from its packaging 1201, as detailed at step 1101. In the present embodiment, the object is packaged in its flat form within a transparent plastic packaging material.

In an alternative embodiment, more than one sheet is sold in a single package. In the present embodiment the sheet is of a similar size to a standard A3 piece of paper, although in alternative embodiments a large variety of sizes are produced.

FIG. 13

Once the net has been removed from its packaging as described with reference to FIG. 12 it must then be popped outfrom the sheet material. The user can then begin to fold the net. FIG. 13 shows the net being folded along one of its score lines. As the lines are pre-scored, this is easily achieved and creates a neat and attractive finish. In the present embodiment, all of the score lines are folded before any of the tabs and slots are joined. Thus, having folded along each score-line, the object starts to take shape and it becomes relatively clear as to which tabs are to be inserted within each slot. However, indications may be provided to facilitate this process such as, in the present embodiment, dots on the tabs to be inserted last. In an alternative embodiment, color coding may be present such that “matching” tabs and slots are coloured accordingly.

FIG. 14

FIG. 14 shows a flap 1401 being folded in order to form a slot 1402. The stepped shape of the cuts enable slots such as 1402 to be formed without the need for a hole to be cut and material to be removed. This is of benefit because during manufacture it would add an extra degree of complexity to the process if holes were to be cut. Once flap 1401 has been folded, slot 1402 is ready to receive a tab. All flaps are folded to create slots before tabs can be inserted.

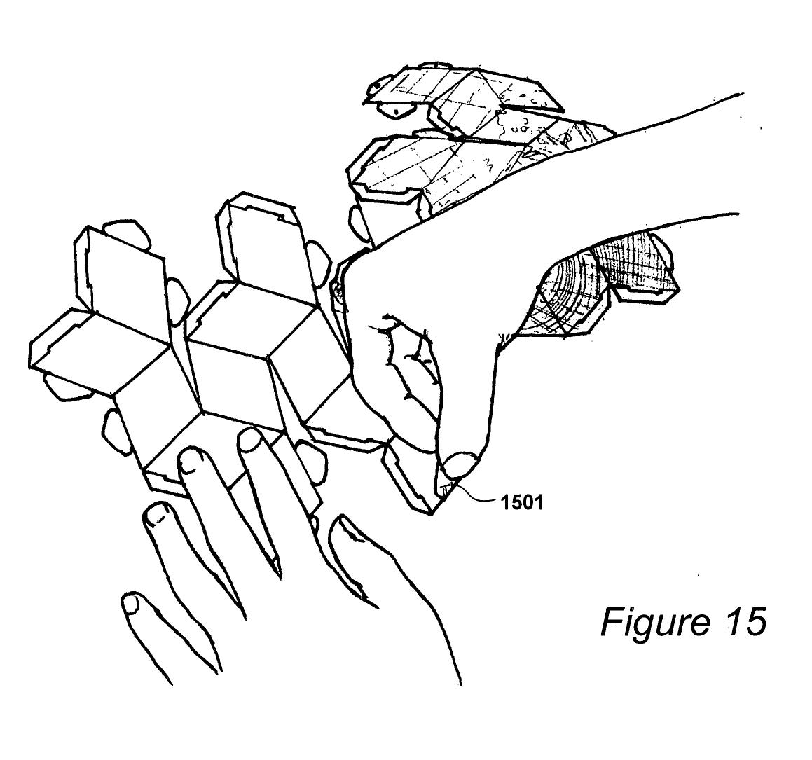

FIG. 15

FIG. 15 shows a tab 1501 being folded in preparation for insertion into a slot. All tabs are pre-folded before insertion into slots.

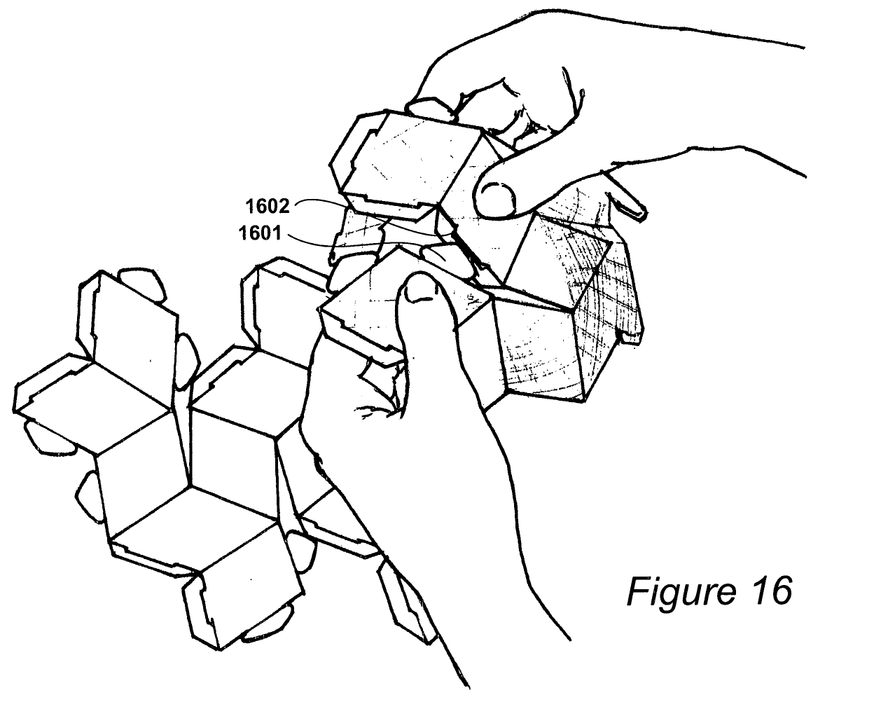

FIG. 16

FIG. 16 shows a tab 1601 being inserted into a slot 1602. Because of the stepped configuration of the cut which forms slot 1602 and the shape of tab 1601, the two fit together comfortably. In addition, due to their respective shapes (as described with reference to FIG. 10), once inserted the tab is effectively locked into position thereby maintaining the shape of the object without the need for glue.

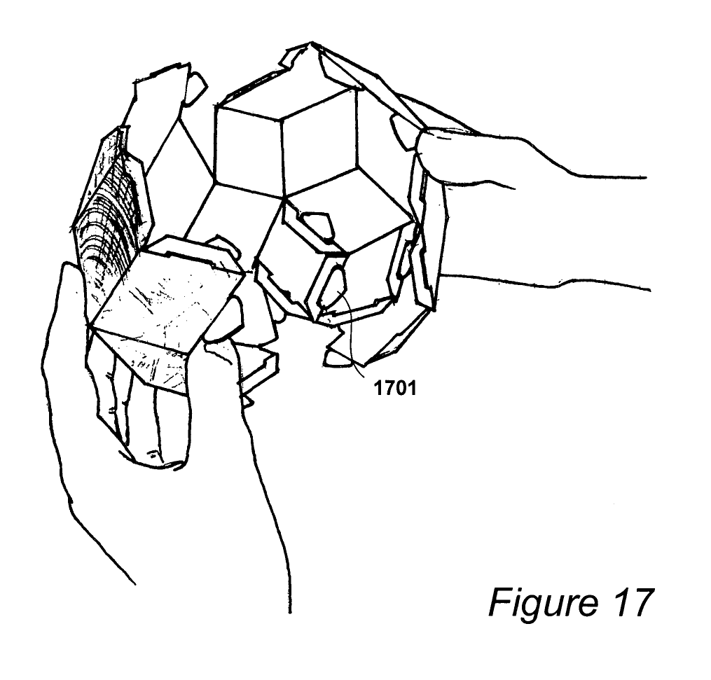

FIG. 17

In FIG. 17, it can be seen that the object is beginning to take shape. Tabs such as tab 1701 can be seen in position holding the object together.

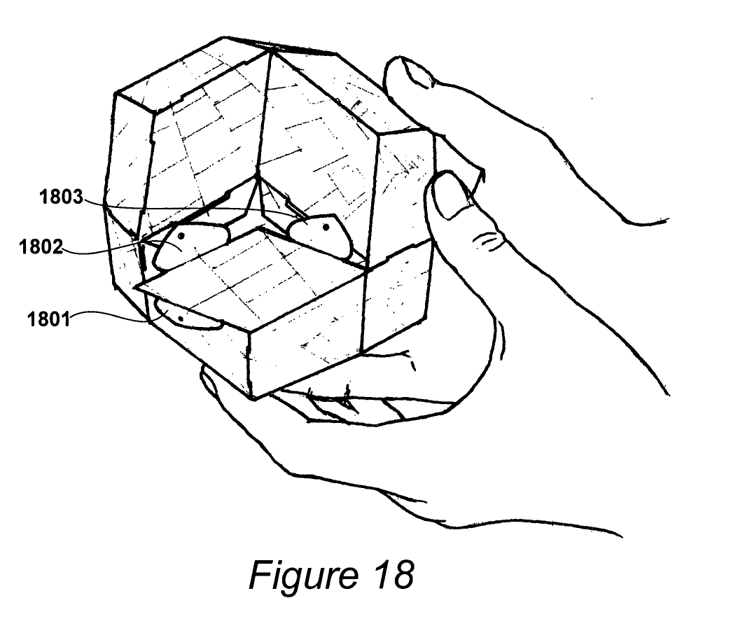

FIG. 18

FIG. 18 shows the object almost complete. In a preferred embodiment specific tabs are identified as being those which must be left until last when assembling the object. In this embodiment, those to be left until last are marked with a dot as shown at 1801, 1802 and 1803. The tabs thus marked are positioned so as to ensure that the object can be assembled with ease and the operator is not left with fiddly insertions to make at the end of assembly.

FIG. 19

FIG. 19 shows the finished object 1901. Because of the manipulations carried out to the image the panorama can be viewed as being in proportion and not distorted from any angle. Thus, as can be appreciated, when assembled this way into the three-dimensional object, the apparent distortions in the image shown in FIG. 7 are made good and a realistic panoramic representation is presented to the viewer.

Because of the configuration of tabs and slots, once assembled the object holds together without the need for glue.

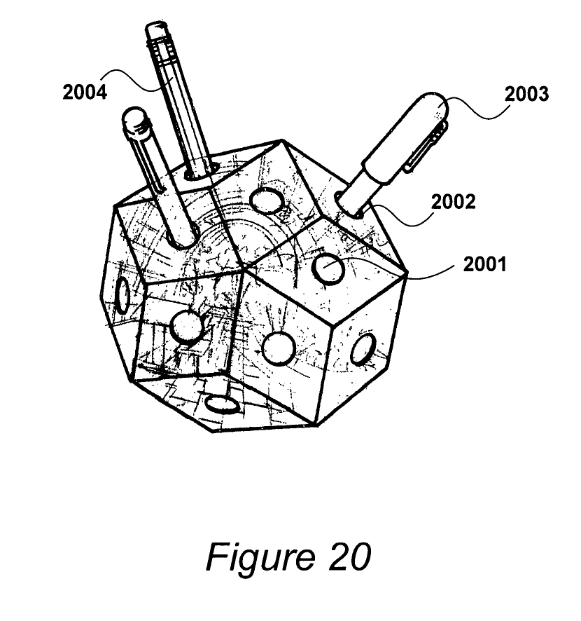

FIG. 20

FIG. 20 shows an alternative embodiment of the present invention, in this case configured to act as a desk tidy. Holes such as 2001 and 2002 are provided such that pens such as pen 2003, pencils such as pencil 2004 etc may be inserted into the holes in the faces of the object. Depending upon the application desired, objects such as that shown in FIG. 20 may have a panoramic image applied to some or all of the surfaces, alongside other material such as wording, advertising, logos etc.

1. A net of regular two-dimensional shapes applied to a sheet material such that said net is foldable into a three-dimensional object, wherein
a panoramic image is applied to said net to present a panorama over said three-dimensional object when assembled; and
said net includes a plurality of tabs and a plurality of slots such that each tab is insertable into a respective one of said slots during the process of assembly into said three-dimensional object.

2. A net according to claim 1, wherein said sheet is card of a sufficient thickness to maintain the rigidity of the object but thin enough to facilitate folding.

3. A net according to claim 2, wherein said card has a protective laminate applied prior to the application of said image.

4. A net according to claim 1, wherein said sheet is a plastics material of a sufficient thickness to maintain the rigidity of the object but thin enough to facilitate folding.

5. A net according to claim 1, wherein said net is scored at foldable edges.

6. A net according to claim 1, wherein said tabs are scored to facilitate folding and insertion into said slots.

7. A net according to claim 1, wherein said slots are defined by flaps containing cuts.

8. A net according to claim 7, wherein said cuts are stepped.

9. A net according to claim 1, wherein each tab extends from an edge of one of said shapes, wherein the width of said tab increases to a size larger than the width of a said slot before decreasing again so as to secure the tab within the slot.

10. A net according to claim 9, wherein said tab increases in width to define a substantially circular curve.

11. A net according to claim 9, wherein said tab decreases in width to define a point.

12. A net according to claim 10, wherein said tabs are substantially spade shaped.

13. A method of assembling a three-dimensional object so as to display a panoramic image, comprising the steps of
applying a panoramic image in the form of a net of two dimensional shapes onto a sheet material;
folding said sheet material along the edges of said shapes; and
inserting tabs that extend from the edges of some of said shapes into respective slots cut at other edges of said shapes.

14. A method according to claim 13, wherein said panoramic image is constructed from a plurality of conventional photographic images.

15. A method according to claim 14, wherein said photographic images are processed to produce an equirectangular projection.

16. A method according to claim 15, wherein said equirectangular projection shows a 360°×180° view.

17. A method according to claim 15, wherein said equirectangular projection is transformed onto a net of regular two-dimensional shapes.

18. A method according to claim 17, wherein said net of regular two-dimensional shapes is printed onto a sheet and said sheet is cut and scored to define said tabs and said slots.

19. A method according to claim 13, wherein said three-dimensional image is a rhombic tricontahedron or a truncated icosahedron.

20. A method according to claim 13, wherein the shape of said net is defined by perforations in a sheet and said object is assembled after removing the net from said sheet manually by tearing away said perforations.
